(19) United States
(12) Patent Application Publication
(10) Pub. No.: US 2026/0055310 A1
(43) Pub. Date: Feb. 26, 2026

(54) MICROWAVE HEATING COMPOSITION AND PREPARATION THEREOF

(71) Applicant: FOSHAN SHUNDE ANBENXIN RUBBER PRODUCTS CO., LTD., FOSHAN (CN)

(72) Inventor: GUOXUE WEN, FOSHAN (CN)

(21) Appl. No.: 19/279,096

(22) Filed: Jul. 24, 2025

(30) Foreign Application Priority Data
Aug. 23, 2024 (CN) 202411165284.X

(51) Int. Cl. C09K 5/14; H05B 6/64

(52) U.S. Cl. CPC C09K 5/14; H05B 6/64

(57) ABSTRACT

A microwave heating composition and a preparation method thereof relating to a field of microwave heating technology are provided. The microwave heating composition is prepared by raw materials. The raw materials include a metal composite powder, an organic silicon rubber composite, a heat-resistant agent, and a vulcanizing agent. The metal composite powder is prepared by growing nickel copper zinc ferrite particles on hollow porous carbon spheres. The microwave heating composition prepared has characteristics of good wave absorption and heating performance, fast heating speed, high heating temperature, strong aging resistance. The microwave heating composition is configured to be used in a microwave oven configured to generate microwaves with a high frequency of about 2.45 GHz.

### TECHNICAL FIELD

The present disclosure relates to a field of microwave heating technology, and in particular to a microwave heating composition and a preparation thereof.

### BACKGROUND

As we all know, the most typical microwave oven supplier is a baking tray of a microwave oven, and a working principle thereof is to use a microwave absorbing material attached to a bottom portion of the baking tray to convert microwave energy into heat energy to heat the baking tray. Therefore, food in the baking tray is heated not only directly by microwaves, but also by the baking tray. This two-way heating mode not only shortens food processing time, but also enables various traditional cooking methods such as frying, deep-frying, stewing, boiling, etc., to be realized in the microwave oven, which greatly increases use functions of the microwave oven and is very popular among users.

In addition, with popularity of microwave ovens and changes in the user populations, users have put forward more and more requirements for microwave heating accessories, especially in terms of usage functions. For example, when frying food by the microwave heating accessories, the food should not be over-fried, and a surface of the food should be kept light brown; when baking steaks and lamb chops by the microwave heating accessories, the steaks and the lamb chops should be tasty and excessive charring must be avoided. Moreover, the users further want to fry chicken legs, make pizza, fry eggs, cook vegetables, cook rice, make traditional clay pot rice, etc., in the microwave oven by the microwave heating accessories.

Conventional microwave ovens generally adopt manganese-zinc ferrite as a microwave absorbing and heating material, which does not meet the requirements of European and American customers and has problems such as slow heating speed, poor temperature stability, and low temperature in a high temperature zone. The main reason is that an application range of the manganese-zinc ferrite is in a lower frequency range of 1 kHz to 5 MHz, while a frequency of the microwaves generated by industrial or household microwave ovens is commonly between 915±25 MHz and 2450±50 MHz.

### SUMMARY

In order to further improve the heating rate and temperature stability of microwave absorbing materials, the present disclosure provides a microwave heating composition and a preparation method thereof.

In a first aspect, the present disclosure provides a microwave heating composition. The microwave heating composition includes following raw materials in parts by weight: 20-50 parts of metal composite powder, 10-12 parts of an organic silicone rubber compound, 0.2-1 part of a heat-resistant agent, and 0.5-1.8 parts of a vulcanizing agent.

In the embodiment, the microwave heating composition is prepared by using the metal composite powder as a main material for absorbing microwave heating energy. Then the metal composite powder, the organic silicon rubber compound, the heat-resistant agent, and the vulcanizing agent are processed to form the microwave heating composition. The microwave heating composition has good microwave absorption and heating performance and is suitable for being used in a microwave oven configured to generate microwaves with a high frequency of about 2.45 GHz.

Optionally, a preparation method of the metal composite powder includes steps:
S1: mixing tetraphenoxysilane, ethyl silicate, ethanol, deionized water, and ammonia water according to a first predetermined proportion to form a first mixed solution, stirring and reacting the first mixed solution for 30-50 minutes at room temperature, adding 2,6-dimethyl-1,4-benzenediol and a formaldehyde solution into the first mixed solution, stirring and reacting for 24-36 hours to obtain a first mixture, centrifugally separating the first mixture to obtain a first precipitate, alternately washing the first precipitate with water and ethanol until supernatant thereof is colorless, and placing a washed first precipitate into a watch glass, and drying the washed first precipitate at 60-70° C.;
S2: calcining a dried first precipitate in an argon atmosphere, and treating a calcined first precipitate with a NaOH solution for 40 minutes to obtain hollow porous carbon spheres;
S3: mixing the deionized water, oleic acid, and the ethanol according to a second predetermined proportion to form a second mixed solution, dispersing the hollow porous carbon spheres and a metal acetate in the second mixed solution, stirring for 40-60 minutes, reacting at 200-220° C. for 10-12 hours, naturally cooling to the room temperature to obtain a second mixture, centrifugally separating the second mixture to obtain a second precipitate, alternately washing the second precipitate with the water and the ethanol until supernatant thereof is colorless, and drying a washed second precipitate at 60-70° C. to obtain a dried second precipitate; and
S4: calcining the dried second precipitate in the argon atmosphere to obtain the metal composite powder.

In the embodiment, a precursor of core-shell coating structures is prepared by using the tetraphenoxysilane, the ethyl silicate, the ammonia water, the 2,6-dimethyl-1,4-benzenediol, and the formaldehyde solution as raw materials of the metal composite powder, then the precursor is etched with the NaOH solution and calcined to form the hollow porous carbon spheres that are porous hollow structures, and then metal acetate and the oleic acid are introduced to form oleic acid metal complexes coating on the hollow porous carbon spheres, and nickel-copper-zinc ferrite particles are formed on inner and outer walls of the hollow porous carbon sphere after calcination to form the metal composite powder having porous hollow carbon magnetic structures, which reduces eddy current loss, minimizes a heat effect other than magnetic loss, and increases wave absorption performance.

Optionally, a mass volume ratio of the tetraphenoxysilane, the ethyl silicate, the ethanol, the water, the ammonia deionized water, the 2,6-dimethyl-1,4-benzenediol and the formaldehyde solution in the step S1 is (1-1.2) g:(2.5-3) mL:(60-80) mL:(10-12) mL:(4.5-5.5) mL:(0.5-0.8) g:(2.5-3) mL.

In the embodiment, the tetraphenoxysilane, the ethyl silicate, the ammonia water, the 2,6-dimethyl-1,4-benzenediol, and the formaldehyde solution are configured as the raw materials of the metal composite powder to polymerize to form the precursor having silane core structures covered with resin shells.

Optionally, a weight percentage of the ammonia water is 25%; and a weight percentage of the formaldehyde solution is 38%.

In the embodiment, the precursor of the core-shell coating structures has an appropriate volume.

Optionally, in the step S2, the dried first precipitate is slowly heated to 700-750° C. at a rate of 2-4° C./min, then the dried first precipitate is calcined at a second constant temperature for 4-5 hours. A concentration of the NaOH solution is 1 mol/L.

In the embodiment, the NaOH solution is configured to etch the calcined first precipitate including silicon dioxide, and then the calcined first precipitate forms the hollow porous carbon spheres.

Optionally, in the step S3, a mass volume ratio of the hollow porous carbon spheres, the metal acetate, and the second mixed solution in the step S3 is (0.5-0.8) g: (0.2-0.4) g:(60-80) mL.

In the embodiment, the metal acetate and the oleic acid are introduced to form the oleic acid metal complexes coating on the hollow porous carbon spheres.

Optionally, a volume ratio of the deionized water, the oleic acid, and the ethanol in the first mixed solution is (1-1.2):(15-20):(80-100). The metal acetate includes iron acetate, zinc acetate, copper acetate, and nickel acetate, and the metal acetate is weighed in a weight ratio of Ni:Cu:Zn:Fe:O=0.4:0.2:0.4:2.0:4.

By adopting the above technical solution, it is beneficial to the crystal formation of the nickel-copper-zinc ferrite particles.

Optionally, when the dried second precipitate is calcined, the dried second precipitate is slowly heated to 780-900° C. at a rate of 3° C./min, then the dried second precipitate is calcined at a first constant temperature for 1-1.5 hours.

In the embodiment, the nickel-copper-zinc ferrite particles have a small size.

In a second aspect, the present disclosure provides a preparation method of the microwave heating composition. The preparation method of the microwave heating composition comprising steps:
mixing the metal composite powder, the organic silicone rubber compound, the adhesive heat-resistant agent and the vulcanizing agent in proportion by an internal mixer at 60-80° C. to prepare a mixed material;
pressing the mixed material into a green sheet with a thickness of 1-3 mm by a calender or an open rubber mixing mill, and cooling the green sheet to the room temperature; and
pressurizing and heating the green sheet to 150-180° C. for vulcanization treatment and shaping, and cooling the green sheet to the room temperature to obtain the microwave heating composition.

A thickness of the green sheet is 1-3 mm.

In the present disclosure, the microwave heating composition is prepared by using the metal composite powder as the main material for absorbing microwave heating. Then, the metal composite powder, the organic silicon rubber compound, the heat-resistant agent, and the vulcanizing agent are processed to form the microwave heating composition. The microwave heating composition has good microwave absorption and heating performance and is suitable for being used in the microwave oven configured to generate microwaves with the high frequency of about 2.45 GHz.

In the present disclosure, the precursor having the core-shell coating structures is prepared by using the tetraphenoxysilane, the ethyl silicate, the ammonia water, the 2,6-dimethyl-1,4-benzenediol, and the formaldehyde solution as the raw materials of the metal composite powder, then the precursor is etched with the NaOH solution and calcined to form the hollow porous carbon spheres that are the porous hollow structures, and then the metal acetate and the oleic acid are introduced to form the oleic acid metal complexes coating on the hollow porous carbon spheres, and the nickel-copper-zinc ferrite particles are formed on the inner and outer walls of the hollow porous carbon sphere after calcination to form the metal composite powder of the porous hollow carbon magnetic structures, which reduces the eddy current loss, minimizes the heat effect other than magnetic loss, and increases the wave absorption performance.

The microwave heating composition prepared by the preparation method of the present disclosure has good microwave absorption and heating performance, fast heating speed, high heating temperature, strong aging resistance, and is able to meet the needs of being used in the microwave oven configured to generate microwaves having the high frequency of about 2.45 GHz.

### BRIEF DESCRIPTION OF DRAWINGS

FIG. 1 is a schematic diagram of hollow porous carbon spheres and metal composite powders prepared in Embodiment 2 of the present disclosure, where an image (a) thereof is a scanning electron microscope (SEM) image of the hollow porous carbon spheres, an image (b) thereof is a transmission electron microscope (TEM) image of the hollow porous carbon spheres, an image (c) thereof is a SEM image of the metal composite powder, and an image (d) thereof is a TEM image of the metal composite powder.

FIG. 2 is an X-ray Diffraction (XRD) spectrum of the metal composite powder prepared in Embodiment 2 of the present disclosure.

FIG. 3 is a schematic diagram of a comparison result of aging test of the microwave heating composition of the present disclosure, where a left image thereof is a schematic diagram of the microwave heating composition prepared in Embodiment 2 before the aging test; a middle image thereof is a schematic diagram of the microwave heating composition prepared in Embodiment 2 after the aging test; and a right image thereof is a schematic diagram of the microwave heating composition prepared in Comparative Example 2 after the aging test.

### DETAILED DESCRIPTION

The present disclosure is further described in detail below in conjunction with the embodiments.

Raw materials of the embodiment and comparative examples of the present disclosure are all commonly available on the market unless otherwise specified.

### Embodiment 1

The embodiment provides a microwave heating composition. The microwave heating composition includes following raw materials in parts by weight: 20 parts of metal composite powder, 10 parts of an organic silicone rubber compound, 0.2 parts of a heat-resistant agent, and 0.5 parts of a vulcanizing agent.

The heat-resistant agent is a heat-resistant agent Bluestar AD703, and the vulcanizing agent is di-tetra-vulcanizing agent.

A preparation method of the metal composite powder includes steps S1-S4.

The S1 includes mixing 1 g of tetraphenoxysilane, 2.5 mL of ethyl silicate, 60 mL of ethanol, 10 mL of deionized water, and 4.5 mL of ammonia water with a weight percentage of 25 wt % to form a first mixed solution, stirring and reacting the first mixed solution for 30 minutes at room temperature, adding 0.5 g of 2,6-dimethyl-1,4-benzenediol and 2.5 mL of a formaldehyde solution with a weight percentage of 38 wt % into the first mixed solution, stirring and reacting for 24 hours to obtain a first mixture, centrifugally separating the first mixture to obtain a first precipitate, alternately washing the first precipitate with water and ethanol until supernatant thereof is colorless, and placing a washed first precipitate into a watch glass, and drying the washed first precipitate at 60° C.

The step S2 includes calcining a dried first precipitate in an argon atmosphere (i.e., the dried first precipitate is slowly heated to 700° C. at a rate of 2° C./min, then the dried first precipitate is calcined at a constant temperature for 4 hours), and treating a calcined first precipitate with a NaOH solution with a concentration of 1 mol/L for 40 minutes to obtain hollow porous carbon spheres.

The step S3 includes mixing the deionized water, oleic acid and the ethanol according to a second predetermined proportion to form a second mixed solution, dispersing 0.5 g of the hollow porous carbon spheres and 0.2 g of a metal acetate in 60 mL of the second mixed solution, stirring for 40 minutes under 20 KHz ultrasonic wave at a rotating speed of 600 r/min, reacting at 200° C. for 10 hours, naturally cooling to the room temperature to obtain a second mixture, centrifugally separating the second mixture to obtain a second precipitate, alternately washing the second precipitate with the water and the ethanol until supernatant thereof is colorless, and drying a washed second precipitate at 60° C. to obtain a dried second precipitate.

Optionally, a volume ratio of the deionized water, the oleic acid, and the ethanol in the first mixed solution is 1:15:80. The metal acetate includes iron acetate, zinc acetate, copper acetate, and nickel acetate, and the metal acetate is weighed in a weight ratio of Ni:Cu:Zn:Fe:O=0.4:0.2:0.4:2.0:4.

The step S4 includes slowly heating the dried second precipitate to 780° C. at a rate of 3° C./min, then the dried second precipitate is calcined at a constant temperature of 780° C.for 1 hour in the argon atmosphere to obtain the metal composite powder.

The embodiment further provides a preparation method of the microwave heating composition. The preparation method of the microwave heating composition comprising steps 1-3.

The step 1 includes mixing the metal composite powder, the organic silicone rubber compound, the adhesive heat-resistant agent and the vulcanizing agent in proportion by an internal mixer at 60° C. to prepare a mixed material.

The step 2 includes pressing the mixed material into a green sheet with a thickness of 3 mm by a calender or an open rubber mixing mill, and cooling the green sheet to the room temperature.

The step 3 includes pressurizing and heating the green sheet to 150° C. for vulcanization treatment and shaping, and cooling the green sheet to the room temperature to obtain the microwave heating composition.

The organic silicone rubber compound is Dow Corning silicone rubber, and a model thereof is SH 52U.

### Embodiment 2

The embodiment provides a microwave heating composition. The microwave heating composition includes following raw materials in parts by weight: 35 parts of the metal composite powder, 11 parts of the organic silicone rubber compound, 0.6 parts of the heat-resistant agent, and 1.2 parts of the vulcanizing agent.

The heat-resistant agent is the heat-resistant agent Bluestar AD703, and the vulcanizing agent is the di-tetra-vulcanizing agent.

A preparation method of the metal composite powder includes steps S1-S4.

The S1 includes mixing 1.1 g of the tetraphenoxysilane, 2.8 mL of the ethyl silicate, 70 mL of the ethanol, 11 mL of the deionized water, and 4.5 mL of the ammonia water with the weight percentage of 25 wt % to form the first mixed solution, stirring and reacting the first mixed solution for 40 minutes at the room temperature, adding 0.65 g of the 2,6-dimethyl-1,4-benzenediol and 2.8 mL of the formaldehyde solution with the weight percentage of 38 wt % into the first mixed solution, stirring and reacting for 30 hours to obtain the first mixture, centrifugally separating the first mixture to obtain the first precipitate, alternately washing the first precipitate with the water and the ethanol until the supernatant thereof is colorless, and placing the washed first precipitate into the watch glass, and drying the washed first precipitate at 65° C.

The step S2 includes calcining the dried first precipitate in the argon atmosphere (i.e., the dried first precipitate is slowly heated to 750° C. at the rate of 3° C./min, then the dried first precipitate is calcined at the constant temperature of 750° C. for 4 hours), and treating the calcined first precipitate with the NaOH solution with the concentration of 1 mol/L for 40 minutes to obtain the hollow porous carbon spheres.

The step S3 includes mixing the deionized water, the oleic acid, and the ethanol to form the second mixed solution, dispersing 0.65 g of the hollow porous carbon spheres and 0.3 g of the metal acetate in 70 mL of the second mixed solution, stirring for 50 minutes under 20 KHz ultrasonic wave at a rotating speed of 700 r/min, reacting at 210° C. for 11 hours, naturally cooling to the room temperature to obtain the second mixture, centrifugally separating the second mixture to obtain the second precipitate, alternately washing the second precipitate with the water and the ethanol until supernatant thereof is colorless, and drying the washed second precipitate at 65° C. to obtain the dried second precipitate.

Optionally, a volume ratio of the deionized water, the oleic acid, and the ethanol in the first mixed solution is 1.1:18:90. The metal acetate includes iron acetate, zinc acetate, copper acetate, and nickel acetate, and the metal acetate is weighed in a weight ratio of Ni:Cu:Zn:Fe:O=0.4:0.2:0.4:2.0:4.

The step S4 includes slowly heating the dried second precipitate to 820° C. at the rate of 3° C./min, then the dried second precipitate is calcined at the constant temperature of 820° C. for 1.5 hours in the argon atmosphere to obtain the metal composite powder.

The embodiment further provides a preparation method of the microwave heating composition. The preparation method of the microwave heating composition comprising steps 1-3.

The step 1 includes mixing the metal composite powder, the organic silicone rubber compound, the adhesive heat-resistant agent and the vulcanizing agent in proportion by an internal mixer at 70° C. to prepare a mixed material.

The step 2 includes pressing the mixed material into the green sheet with a thickness of 2 mm by the calender or the open rubber mixing mill, and cooling the green sheet to room temperature.

The step 3 includes pressurizing and heating the green sheet to 165° C. for vulcanization treatment and shaping, and cooling the green sheet to the room temperature to obtain the microwave heating composition.

The organic silicone rubber compound is Dow Corning silicone rubber, and a model thereof is SH 52U.

### Embodiment 3

The embodiment provides a microwave heating composition. The microwave heating composition includes following raw materials in parts by weight: 50 parts of the metal composite powder, 10 parts of the organic silicone rubber compound, 1 part of the heat-resistant agent, and 1.8 parts of the vulcanizing agent.

The heat-resistant agent is the heat-resistant agent Bluestar AD703, and the vulcanizing agent is the di-tetra-vulcanizing agent.

A preparation method of the metal composite powder includes steps S1-S4.

The S1 includes mixing 1.2 g of the tetraphenoxysilane, 3 mL of the ethyl silicate, 80 mL of the ethanol, 12 mL of the deionized water, and 5.5 mL of the ammonia water with the weight percentage of 25 wt % to form the first mixed solution, stirring and reacting the first mixed solution for 50 minutes at the room temperature, adding 0.8 g of the 2,6-dimethyl-1,4-benzenediol and 3 mL of the formaldehyde solution with the weight percentage of 38 wt % into the first mixed solution, stirring and reacting for 36 hours to obtain the first mixture, centrifugally separating the first mixture to obtain the first precipitate, alternately washing the first precipitate with the water and the ethanol until the supernatant thereof is colorless, and placing the washed first precipitate into the watch glass, and drying the washed first precipitate at 70° C.

The step S2 includes calcining the dried first precipitate in the argon atmosphere (i.e., the dried first precipitate is slowly heated to 750° C. at a rate of 4° C./min, then the dried first precipitate is calcined at the constant temperature of 750° C. for 5 hours), and treating the calcined first precipitate with the NaOH solution with the concentration of 1 mol/L for 40 minutes to obtain the hollow porous carbon spheres.

The step S3 includes mixing the deionized water, the oleic acid, and the ethanol to form the second mixed solution, dispersing 0.8 g of the hollow porous carbon spheres and 0.4 g of the metal acetate in 80 mL of the second mixed solution, stirring for 60 minutes under 20 KHz ultrasonic wave at a rotating speed of 800 r/min, reacting at 220° C. for 12 hours, naturally cooling to the room temperature to obtain the second mixture, centrifugally separating the second mixture to obtain the second precipitate, alternately washing the second precipitate with the water and the ethanol until supernatant thereof is colorless, and drying the washed second precipitate at 70° C. to obtain the dried second precipitate.

Optionally, a volume ratio of the deionized water, the oleic acid, and the ethanol in the first mixed solution is 1.2:20:100. The metal acetate includes iron acetate, zinc acetate, copper acetate, and nickel acetate, and the metal acetate is weighed in a weight ratio of Ni:Cu:Zn:Fe:O=0.4:0.2:0.4:2.0:4.

The step S4 includes slowly heating the dried second precipitate to 900° C. at the rate of 3° C./min, then the dried second precipitate is calcined at the constant temperature of 900° C. for 1.5 hours in the argon atmosphere to obtain the metal composite powder.

The embodiment further provides a preparation method of the microwave heating composition. The preparation method of the microwave heating composition comprising steps 1-3.

The step 1 includes mixing the metal composite powder, the organic silicone rubber compound, the adhesive heat-resistant agent and the vulcanizing agent in proportion by an internal mixer at 80° C. to prepare a mixed material.

The step 2 includes pressing the mixed material into the green sheet with a thickness of 1 mm by the calender or the open rubber mixing mill, and cooling the green sheet to the room temperature.

The step 3 includes pressurizing and heating the green sheet to 180° C. for vulcanization treatment and shaping, and cooling the green sheet to the room temperature to obtain the microwave heating composition.

The organic silicone rubber compound is Dow Corning silicone rubber, and a model thereof is SH 52U.

### Comparative Example 1

Comparative Example 1 is substantially the same as Embodiment 2, except that the oleic acid is not added during the preparation of the metal composite powder.

### Comparative Example 2

Comparative Example 2 is substantially the same as Embodiment 2, except that in the step S4, the dried second precipitate is calcined at the constant temperature of 700° C.

### Comparative Example 3

Comparative Example 3 is substantially the same as Embodiment 2, and the differences thereof are as follows.

Metal powder includes Ni_{0.4}Cu_{0.2}Zn_{0.4}Fe_{2.0}O₄, and Fe₂O₃, CuO, NiO, ZnO are weighed in a weight ratio of Ni:Cu:Zn:Fe:O=0.4:0.2:0.4:2.0:4.

The Fe₂O₃, CuO, NiO, ZnO powder is strongly mixed in a strong mixer for 12 hours; mixed powder is heated to 1500° C. in a sintering furnace at a rate of 15° C./min and sintered for 24 hours, and then cooled to the room temperature. Sintered powder is sand-milled for 36 hours, dried for 72 hours, and passed through a 500-mesh sieve to obtain the metal powder.

The metal powder and the hollow porous carbon spheres are mixed according to a mass ratio of total metal atoms to the hollow porous carbon spheres in Embodiment 2 to replace the metal composite powder to prepare the microwave heating composition.

### Comparative Example 4

Comparative Example 4 is substantially the same as Embodiment 2, and the differences thereof are as follows.

In a process of preparing the microwave heating composition, nitrile rubber (purchased from Anqing Hualan Technology Co., Ltd.) replaces the silicone rubber composite, and manganese zinc ferrite nanocrystals (purchased from Zhongke Leiming (Beijing) Technology Co., Ltd.) replaces the metal composite powder to prepare the microwave heating composition.

### Performance Test

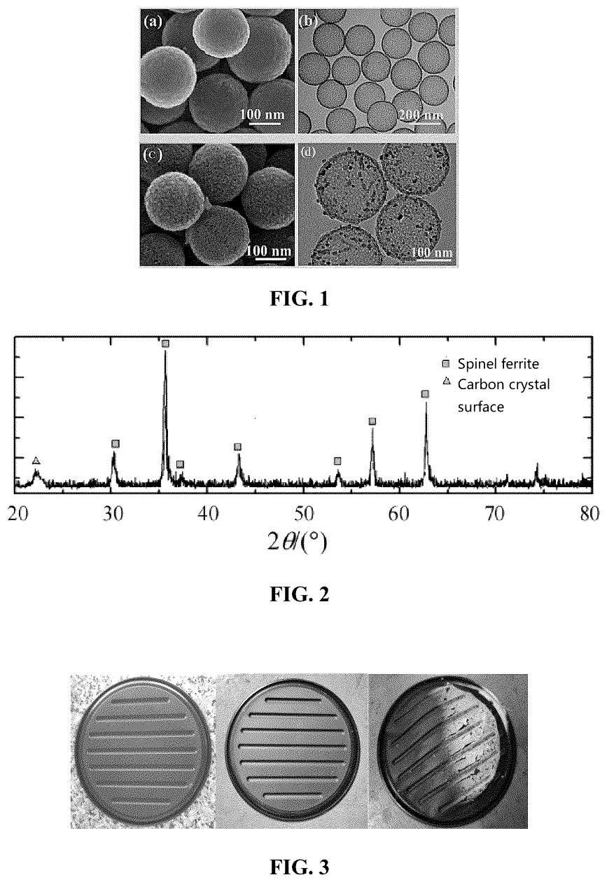

The microscopic morphology of the hollow porous carbon spheres and the metal composite powders prepared in Embodiment 2 is observed through a scanning electron microscope (SEM) and a transmission electron microscope (TEM). Results are shown in FIG. 1.

As can be seen from the image (a) and the image (b), a structure of the hollow porous carbon spheres is porous hollow spherical, uniform in size, smooth on a surface thereof, and with a particle size of about 170 nm. As can be seen from the image (c) and the image (d), a structure of the metal composite powder is still porous hollow spherical, a diameter thereof is greater than that of the hollow porous carbon spheres, the dispersion is high, the surface thereof is rough, and small particles are attached to the inner and outer walls of the hollow porous carbon spheres.

Phase analysis of particles attached to the surface of the metal composite powder prepared in Embodiment 2 is performed by an X-ray diffractometer, and results are shown in FIG. 2.

As can be seen from FIG. 2, in the metal composite powder prepared in Embodiment 2, the particles attached to the surface of the hollow porous carbon spheres are ferrite powders of a spinel structure phase.

The microwave heating compositions prepared in Embodiments 1-3 and Comparative Examples 1-3 are attached to a bottom portion of a baking tray for a microwave oven (a specification of the baking tray is Ø290), and then the baking tray is placed in the microwave oven and heated by microwaves at a high frequency of 2.45 GHz and a power of 800 W. Temperatures of a center of the baking tray are recorded over time. The results are shown in Table 1. Table 1 shows the temperature at the center of the baking tray changing with time in the present disclosure, where T represent the time and temp. represents the temperature.

TABLE 1

| | Temp. (° C.) | | | | | |
|---|---|---|---|---|---|---|
| | Embodi- | Embodi- | Embodi- | Exam- | Exam- | Exam- |
| T(s) | ment 1 | ment 2 | ment 3 | ple 1 | ple 2 | ple 3 |
| 0 | 22 | 22 | 22 | 22 | 22 | 22 |
| 30 | 74 | 73 | 74 | 45 | 68 | 58 |
| 60 | 126 | 125 | 124 | 75 | 115 | 102 |
| 90 | 168 | 168 | 166 | 91 | 153 | 124 |
| 120 | 196 | 194 | 195 | 123 | 184 | 145 |
| 150 | 210 | 208 | 209 | 139 | 201 | 167 |
| 180 | 221 | 222 | 220 | 143 | 213 | 178 |
| 210 | 224 | 223 | 223 | 145 | 215 | 180 |
| 240 | 226 | 224 | 225 | 145 | 216 | 182 |
| 300 | 229 | 228 | 228 | 145 | 217 | 183 |
| 600 | 229 | 229 | 229 | 145 | 217 | 183 |
| 1200 | 230 | 229 | 229 | 145 | 217 | 183 |

As can be seen from Table 1, the microwave heating compositions prepared in Embodiments 1-3 heat up quickly and have a high heating temperature.

The microwave heating compositions prepared in Embodiment 2 and Comparative Example 4 are attached to the bottom portion of the baking tray and heated at 350° C. for 2 hours, and an aging test is performed. Results are shown in FIG. 3.

As can be seen from FIG. 3, after the microwave heating composition prepared in Embodiment 2 of the present disclosure is heated at 350° C. for 2 hours and aged, the microwave heating composition is slightly brittle, while the microwave heating composition prepared in Comparative Example 4 is carbonized, indicating that the microwave heating composition prepared in Embodiment 2 of the present disclosure has better heat resistance and aging resistance.

The embodiments are merely an explanation of the present disclosure and are not intended to limit the present disclosure. Those skilled in the art may make modifications without creative contributions to the present embodiment according to needs after reading the specification, as long as the protection scope claimed by the present disclosure is protected by the patent laws.

What is claimed is:

1. A microwave heating composition, comprising following raw materials in parts by weight:
20-50 parts of metal composite powder;
10-12 parts of an organic silicone rubber compound;
0.2-1 part of a heat-resistant agent; and
0.5-1.8 parts of a vulcanizing agent;
wherein in a preparation method of the metal composite powder comprises steps:
S1: mixing tetraphenoxysilane, ethyl silicate, ethanol, deionized water, and ammonia water according to a first predetermined proportion to form a first mixed solution, stirring and reacting the first mixed solution for 30-50 minutes at a room temperature, adding 2,6-dimethyl-1,4-benzenediol and a formaldehyde solution into the first mixed solution, stirring and reacting for 24-36 hours to obtain a first mixture, centrifugally separating the first mixture to obtain a first precipitate, alternately washing the first precipitate with water and the ethanol until supernatant thereof is colorless, and placing a washed first precipitate into a watch glass, and drying the washed first precipitate at 60-70° C.;
S2: calcining a dried first precipitate in an argon atmosphere, and treating a calcined first precipitate with a NaOH solution for 40 minutes to obtain hollow porous carbon spheres;
S3: mixing the deionized water, oleic acid and the ethanol according to a second predetermined proportion to form a second mixed solution, dispersing the hollow porous carbon spheres and a metal acetate in the second mixed solution, stirring for 40-60 minutes, reacting at 200-220° C. for 10-12 hours, naturally cooling to the room temperature to obtain a second mixture, centrifugally separating the second mixture to obtain a second precipitate, alternately washing the second precipitate with the water and the ethanol until supernatant thereof is colorless, and drying a washed second precipitate at 60-70° C. to obtain a dried second precipitate; and
S4: calcining the dried second precipitate in the argon atmosphere to obtain the metal composite powder,
wherein the metal acetate comprises iron acetate, zinc acetate, copper acetate, and nickel acetate, and the metal acetate is weighed in a weight ratio of Ni:Cu:Zn:Fe:O=0.4:0.2:0.4:2.4;
wherein when the dried second precipitate is calcined, the dried second precipitate is slowly heated to 780-900° C. at a rate of 3° C./min, then the dried second precipitate is calcined at a first constant temperature for 1-1.5 hours.

2. The microwave heating composition according to claim 1, wherein a mass volume ratio of the tetraphenoxysilane, the ethyl silicate, the ethanol, the deionized water, the ammonia water, the 2,6-dimethyl-1,4-benzenediol and the formaldehyde solution in the step S1 is (1-1.2) g:(2.5-3) mL:(60-80) mL:(10-12) mL:(4.5-5.5) mL:(0.5-0.8) g:(2.5-3) mL.

3. The microwave heating composition according to claim 2, wherein a weight percentage of the ammonia water is 25%, and a weight percentage of the formaldehyde solution is 38%.

4. The microwave heating composition according to claim 3, wherein in the step S2, the dried first precipitate is slowly heated to 700-750° C. at a rate of 2-4° C./min, then the dried first precipitate is calcined at a second constant temperature for 4-5 hours;
wherein a concentration of the NaOH solution is 1 mol/L.

5. The microwave heating composition according to claim 4, wherein a mass volume ratio of the hollow porous carbon spheres, the metal acetate, and the second mixed solution in the step S3 is (0.5-0.8) g:(0.2-0.4) g:(60-80) mL.

6. The microwave heating composition according to claim 5, wherein a volume ratio of the deionized water, the oleic acid, and the ethanol in the second mixed solution is (1-1.2):(15-20):(80-100).

7. A preparation method of the microwave heating composition according to claim 1, comprising steps:
mixing the metal composite powder, the organic silicone rubber compound, the adhesive heat-resistant agent and the vulcanizing agent by an internal mixer at 60-80° C. to prepare a mixed material;
pressing the mixed material into a green sheet with a thickness of 1-3 mm by a calender or an open rubber mixing mill, and cooling the green sheet to the room temperature; and
pressurizing and heating the green sheet to 150-180° C. for vulcanization treatment and shaping, and cooling the green sheet to the room temperature to obtain the microwave heating composition.
